(19) United States
(12) Patent Application Publication
(10) Pub. No.: US 2005/0052729 A1
(43) Pub. Date: Mar. 10, 2005

(54) Optical encoder

(76) Inventors: Muneo Mitamura, Nagano-ken (JP); Yoshinori Ito, Nagano-ken (JP); Sadaharu Kanamori, Nagano-ken (JP)

Correspondence Address: BURNS DOANE SWECKER & MATHIS L L P, POST OFFICE BOX 1404, ALEXANDRIA, VA, 22313-1404, US

(21) Appl. No.: 10/697,322

(22) Filed: Oct. 31, 2003

(30) Foreign Application Priority Data
Nov. 14, 2002 (JP) 2002-330391

(51) Int. Cl. H01S 3/00

(52) U.S. Cl. 359/337.21

(57) ABSTRACT

A projection-type linear encoder has a moving grating plate formed with a set of photodiodes for detecting an origin position and a reflective grating plate formed with reflective grating sections for detecting an origin position. The set of photodiodes for detecting an origin position includes photodiodes (5Z, 5Z1, 5Z′, 5Z1′) that are aligned in accordance with an alignment pattern produced using random numbers, and the reflective grating sections for detecting the origin position include reflective grating sections and non-reflective grating sections that are wider than grating sections for detecting an A phase signal and a B phase signal similarly disposed in accordance with an alignment pattern produced using random numbers. The origin position of the moving grating plate can be precisely detected based on a differential signal of photodiodes (5Z) and photodiodes (5Z′) and a differential signal of photodiodes (5Z1, 5Z1′) that differ in phase by 90° to the photodiodes (5Z, 5Z′).

### BACKGROUND OF THE INVENTION

1. Field of the Invention

The present invention relates to an optical encoder, such as a projection encoder, based on triple grating concept, and in particular to an optical encoder with a small, compact construction that is capable of precisely generating an origin position signal for detecting positions.

2. Related Art

Optical rotary encoders and linear encoders are normally configured so as to output a signal called a “Z phase” signal for detecting an origin position. FIG. 7 shows examples of signal output waveforms of an A phase signal and a B phase signal and a signal output waveform of the Z phase signal. It is necessary to detect the origin position as an absolute position from the relationship between the A, B, and Z phase signals, so that a pulse width e of the Z phase signal needs to be approximately equal to a width T of one pulse of the A phase signal and the B phase signal.

In order to detect the Z phase signal, in the case of a rotary encoder, for example, it is sufficient to provide one slit per rotation and to detect light that passes through this slit. FIGS. 8A and 8B show the theory behind this. As shown in FIG. 8A, when a single slit 102 provided in one position per rotation in a rotational disc 101 is aligned with a slit 104 of a fixed disc 103, light from an LED 105 reaches a photodiode 106 and a signal such as that shown in FIG. 8B is generated. As one example, this output signal is inputted into a comparator, and compared with a threshold TH of the comparator, so that a rectangular waveform output of a Z phase signal can be obtained. The signal pulse width e can be changed by varying the threshold voltage.

In order to make the signal pulse width e of the Z phase signal approximately equal to the signal pulse width T of the A and B phase signals, the slit width for the Z phase needs to be set equal to the slit widths for the A and B phases. However, since the slit width becomes narrow when the encoder has high resolution, it becomes difficult to ensure that sufficient light is received for detecting the Z phase signal. In particular, when a gap between the rotational disc and the fixed disc is wide, a transmitted image of a narrow slit becomes blurred, which makes it difficult to precisely detect the Z phase signal.

### SUMMARY OF THE INVENTION

The present invention was conceived in view of the above problem and it is an object of the present invention to provide an optical encoder equipped with an origin position detecting mechanism that can precisely generate a Z phase signal even when the width of grating sections is narrow and a gap between the grating plates is wide.

In order to achieve the stated object, one aspect of the present invention is a projection-type optical encoder including a light emitting element, a moving grating plate with moving side transmissive grating sections of a predetermined width that are aligned at a fixed pitch, a fixed grating plate with fixed side transmissive grating sections of a predetermined width that are aligned at a fixed pitch, and a set of light receiving elements that receive light that has been emitted from the light source and has passed through the moving side transmissive grating sections and the fixed side transmissive grating sections,

the optical encoder further including an origin position detecting mechanism for detecting an origin position of the moving grating plate,

wherein the origin position detecting mechanism includes a moving side grating region for origin position detection that is formed on the moving grating plate, a fixed side grating region for origin position detection that is formed on the fixed grating plate, and a set of light receiving elements for origin position detection that are included in the set of light receiving elements,

transmissive grating sections for origin detection and non-transmissive grating sections for origin detection that are wider than the moving side transmissive grating sections and the fixed side transmissive grating sections are aligned in the moving side grating region and the fixed side grating region, respectively, in accordance with an M-series arrangement pattern or an alignment produced from random numbers, for example,

the set of light receiving elements for origin position detection includes a set of Z phase light receiving elements that generate a Z phase signal and a set of Z′ phase light receiving elements that generate a Z′ phase signal that differs in phase to the Z phase signal, the Z phase light receiving elements being aligned in accordance with an M-series arrangement pattern or an alignment produced from random numbers, for example, and

the origin position of the moving grating plate is detected based on the Z phase signal and the Z′ phase signal.

According to the present invention, a plurality of transmissive grating sections for detecting the origin position are aligned in accordance with an M-series arrangement pattern or an alignment produced from random numbers and the width of the transmissive grating sections for detecting the origin position are made wider than the transmissive grating sections for generating the A phase signal and the B phase signal, so that it can be ensured that sufficient light is received by the Z phase light receiving elements as a whole, even in a case where the transmissive grating sections for generating the A phase signal and the B phase signal are narrow (i.e., when the encoder has high resolution). In addition, since the Z phase signal and the Z′ phase signal that differ in phase by 90° for example are generated, by using these signals it is possible to easily generate the Z phase signal with the same pulse width as the A phase signal and the B phase signal.

Here, it is preferable for the set of light receiving elements to include a set of inverse Z phase light receiving elements that generate an inverse Z phase signal that is an inverse signal of the Z phase signal and a set of inverse Z′ phase light receiving elements that generate an inverse Z′ phase signal that is an inverse signal of the Z′phase signal, and for the origin position of the moving grating plate to be detected based on a differential signal of the Z phase signal and the inverse Z phase signal and a differential signal of the Z′ phase signal and the inverse Z′ phase signal. By using such differential signals, it is possible to detect the origin position with higher precision.

The present invention can be applied in the same way to a reflective-type optical encoder. That is, another aspect of the present invention is a reflective-type optical encoder including a light emitting element, a moving grating plate with moving side reflective grating sections of a predetermined width that are aligned at a fixed pitch, a fixed grating plate with fixed side transmissive grating sections of a predetermined width that are aligned at a fixed pitch, and a set of light receiving elements that receive light that has been emitted from the light source, reflected by the moving side reflective grating sections, and has passed through the fixed transmissive grating sections,

the optical encoder further including an origin position detecting mechanism for detecting an origin position of the moving grating plate,

wherein the origin position detecting mechanism includes a moving side grating region for origin position detection that is formed on the moving grating plate, a fixed side grating region for origin position detection that is formed on the fixed grating plate, and a set of light receiving elements for origin position detection that are included in the set of light receiving elements,

reflective grating sections for origin position detection and non-reflective grating sections for origin position detection that are wider than the moving side reflective grating sections and the fixed side transmissive grating sections are aligned in the moving side grating region and the fixed side grating region, respectively, in accordance with an M-series arrangement pattern or an alignment produced from random numbers,

transmissive grating sections for origin position detection and non-transmissive grating sections for origin position detection that are wider than the moving side reflective grating sections and the fixed side transmissive grating sections are aligned in the fixed side grating region in accordance with an M-series arrangement pattern or an alignment produced from random numbers,

the set of light receiving elements for origin position detection includes a set of Z phase light receiving elements that generate a Z phase signal and a set of Z′ phase light receiving elements that generate a Z′ phase signal that differs in phase to the Z phase signal, the set of Z phase light receiving elements being aligned in accordance with an M-series arrangement pattern or an alignment produced from random numbers, and

the origin position of the moving grating plate is detected based on the Z phase signal and the Z′ phase signal.

In the above case also, it is preferable for the set of light receiving elements to include a set of inverse Z phase light receiving elements that generate an inverse Z phase signal that is an inverse signal of the Z phase signal and a set of inverse Z′ phase light receiving elements that generate an inverse Z′ phase signal that is an inverse signal of the Z′ phase signal, and for the origin position of the moving grating plate to be detected based on a differential signal of the Z phase signal and the inverse Z phase signal and a differential signal of the Z′ phase signal and the inverse Z′ phase signal.

### BRIEF DESCRIPTION OF THE DRAWINGS

FIG. 1 is a schematic diagram showing a projection-type linear encoder based on triple grating concept according to the present invention.

FIG. 2 is a simplified side view showing a positional relationship between a moving grating plate, a reflective grating plate, and a light source.

FIG. 3 shows an alignment pattern of reflective grating sections formed on the surface of the reflective grating plate of FIG. 1 and the alignment pattern of photodiodes for generating a Z phase signal that are formed on the moving grating plate.

FIG. 4 is a schematic diagram showing arrangement patterns of transmissive grating sections and sets of photodiodes formed in the moving grating plate of FIG. 1.

FIG. 5 is an enlarged partial cross-sectional view showing a part of the moving grating plate of FIG. 1 where the transmissive grating sections are formed.

FIG. 6 is an enlarged partial cross-sectional view showing a part of the photodiodes formed in the moving grating plate of FIG. 1.

FIG. 7 is a waveform diagram showing signal waveforms of A, B, and Z phase signals in an optical encoder.

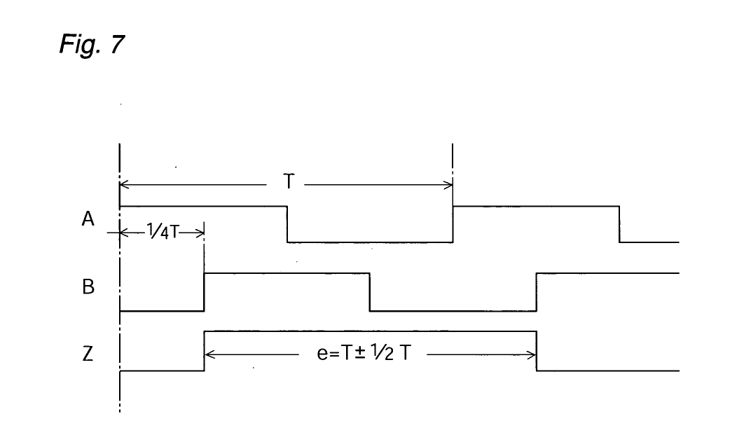

FIG. 8A is an explanatory view showing a typical structure of an optical rotary encoder, and FIG. 8B is a signal waveform diagram showing a detection signal obtained from a light receiving element for detecting an origin position of the optical rotary encoder and a Z phase signal.

FIG. 9 shows the theory behind detection of an origin signal based on slits aligned in accordance with an M-series arrangement pattern.

FIG. 10 shows slits for generating signals that differ in phase by 90° and are used for detecting an origin position, and the theory behind the generation of an origin signal from generated signals.

### DESCRIPTION OF THE PREFERRED EMBODIMENTS

An optical encoder according to the present invention will now be described with reference to the attached drawings.

### DETECTION PRINCIPLE

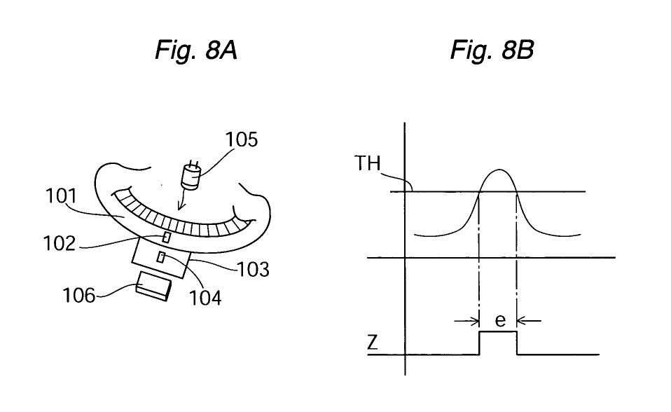

First, a principle for detecting an origin position by an optical encoder according to the present invention will be described. In order to obtain sufficient light for detecting a Z phase, in the optical encoder shown in FIG. 8A, it is preferable to employ a plurality of slits for Z phase detection that are disposed in accordance with an M-series arrangement pattern. US-2003-0155491-A1 assigned to the same assignee of the present invention discloses that slits for Z phase detection are aligned in accordance with an M-series arrangement pattern, the contents of which are incorporated herein by reference. By using this configuration, it is possible to ensure that sufficient light is incident on light receiving elements for Z phase detection.

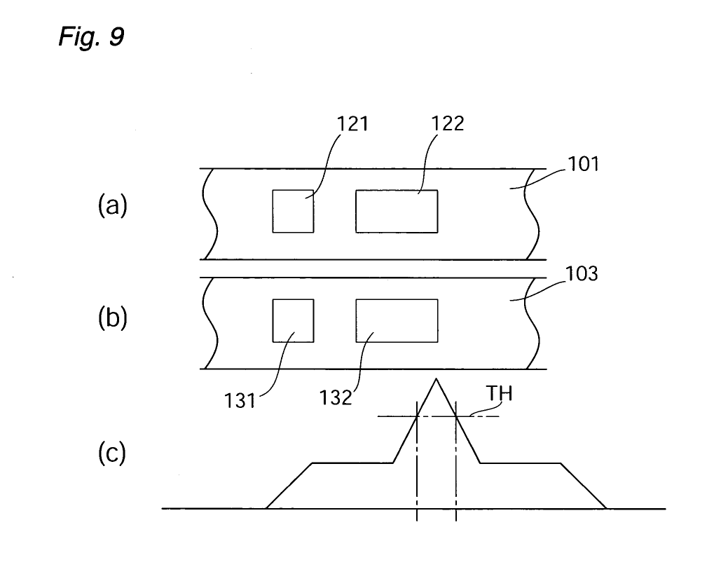

FIGS. 9(a) and (b) show Z phase detection slits 121, 122 that are formed in a rotational disc 101 of the optical encoder shown in FIG. 8A in accordance with an M-series arrangement pattern and Z phase detection slits 131, 132 that are formed in a fixed disc 103 in accordance with an M-series arrangement pattern. The light receiving elements for receiving light that passes through these slits are respectively disposed at a position opposite to the slit 131 and a position opposite to the slit 132.

In this case, due to a relative rotation of the fixed disc 103 and the rotational disc 101, the amount of light received by the light receiving elements (i.e., the amount of light that passes through the slits) varies as shown in FIG. 9(c). In this way, compared to a case where only one slit is used for detecting the Z phase, it is possible to obtain a steep and higher peak waveform. Accordingly, by comparing a photoelectric converted signal (Z phase detection signal) outputted from the light receiving elements with a predetermined threshold value TH in a comparator, it is possible to generate a Z phase signal that has the same pulse width as the A and B phase signals.

Here, when the optical encoder is a reflective-type or a projection-type optical encoder, a gap between the rotational disc and the fixed disc is wide. Accordingly, as in a parallel-beam optical encoder, if the Z phase slit pattern is formed based on a pattern pitch of the slits for the A and B phases, the width of the slits is narrow, so that an outlines of the slit light images become blurred and there are cases where it is not possible to obtain precise signals.

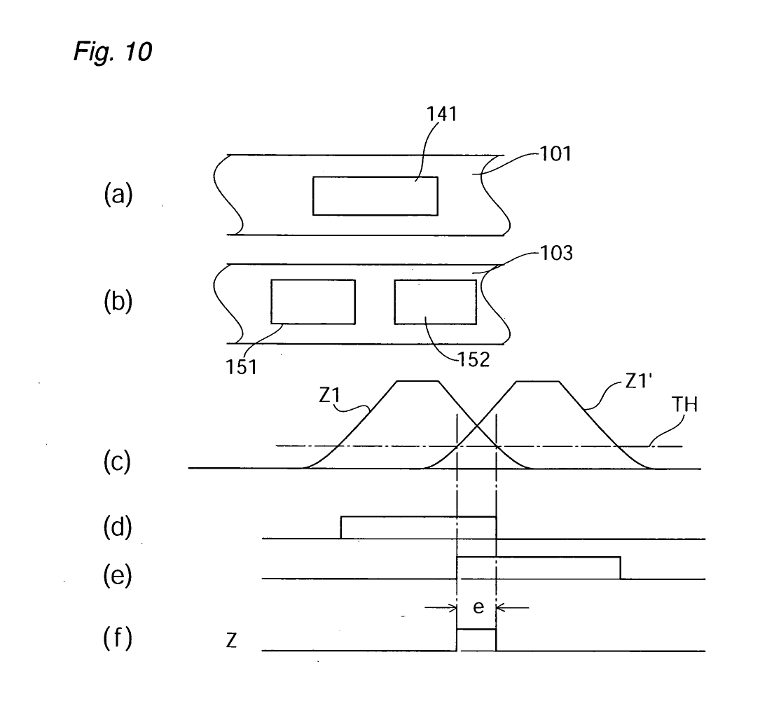

For this reason, as shown in FIGS. 10(a) and (b), compared to the slits used for generating the A phase signal and the B phase signal, a wide slit 141 for generating the Z phase signal is formed in the rotational disc 101 and two wide slits 151, 152 are formed in the fixed disc 103 so that signals that differ in phase, for example by 90°, can be generated. Slits are formed in this way in advance and light receiving elements are disposed at positions opposite to the slits 151, 152. A Z1 signal and a Z1′ signal that differ in phase by 90° are obtained from these light receiving elements, as shown in FIG. 10(c). These signals are respectively compared with a predetermined threshold value TH in comparators, and by taking a logical AND for outputs of the comparators (see FIGS. 10(d) and (e)), it is possible to generate a Z phase signal with a predetermined pulse width e (see FIG. 10(f).

However, in a case of a projection-type optical encoder, a gap between the rotational disc and the fixed disc is set at 2 mm or wider, so that there are cases where the Z phase signal cannot be detected precisely using the method shown in FIG. 9 or the method shown in FIG. 10. That is, with the method shown in FIG. 10, there is a limit on how wide openings (slits) 151, 152 of the fixed disc 103 can be made (it is not possible to make the openings large while keeping the phase difference between the Z1 and Z1′ signals small) so that if the gap between the discs 101 and 103 is wide, there is more leakage of light, resulting in a fall in a signal to noise ratio. With the method shown in FIG. 9 where a M-series arrangement pattern is used, the amount of light received by the light receiving elements for Z phase detection can be increased, so that the S/N ratio can be improved, but when a pitch of the slits is narrow, the use of incoherent light as the light source results in interference in images formed on the light receiving elements, resulting in a fall of the S/N ratio.

According to the present invention, by using a method that is a combination of the method shown in FIG. 9 and the method shown in FIG. 10, a configuration is used where the width of the slits for Z phase detection is set sufficiently larger than the width of the slits for A, B phase detection. According to the present invention, even in a case where the gap between the gratings is wide, as in a reflective-type or a projection-type optical encoder, a Z phase signal with a high output level and high contrast can be obtained.

### EXAMPLE

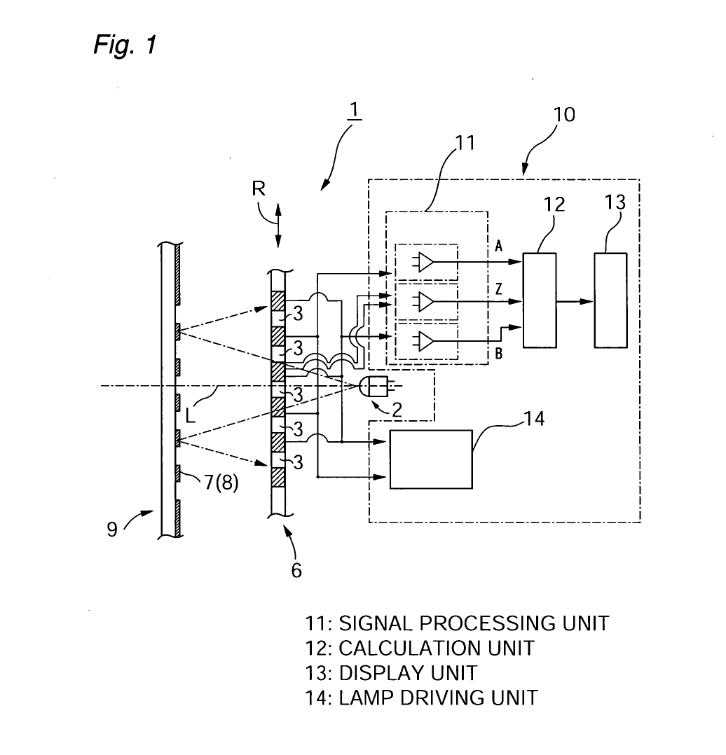

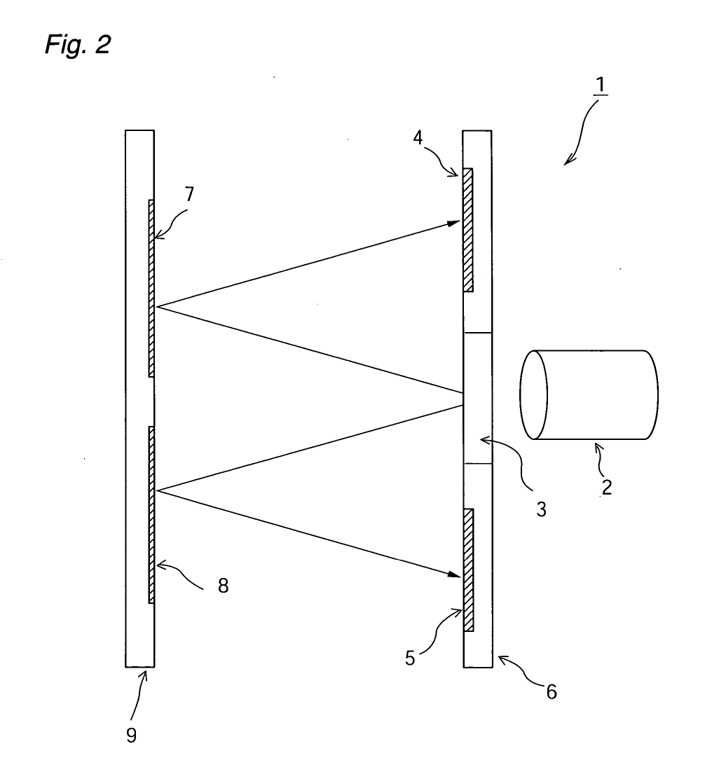

FIG. 1 is a schematic diagram showing the overall construction of a projection-type linear encoder according to an embodiment of the present invention, while FIG. 2 is a simplified side view of a main part of the linear encoder. As shown in these drawings, a projection-type linear encoder 1 has a construction that basically includes a light source 2 such as an LED or a halogen lamp, a moving grating plate 6 composed of a semiconductor substrate in which a transmissive grating 3 and sets of photodiodes 4 and 5 are embedded, a reflective grating plate (fixed grating plate) 9 that has reflective gratings 7 and 8 formed on a surface thereof, and a control circuit unit 10. Light emitted from the light source 2 passes thorough the transmissive grating 3 formed in the moving grating plate 6 and becomes incident on the reflective gratings 7 and 8 of the reflective grating plate 9. A reflected light image reflected by the sets of reflective gratings 7 and 8 is received by the sets of photodiodes 4 and 5, and detection signals of the sets of photodiodes 4 and 5 are supplied to the control circuit unit 10.

The control circuit unit 10 includes a signal processing unit 11 that forms, based on the detection signals of the sets of photodiodes 4 and 5, an A phase signal and a B phase signal that are shifted in phase by λ/4 and also a Z phase signal that shows an origin position of the moving grating plate 6, a calculation unit 12 that calculates movement information such as a movement speed, movement direction, and movement position of the moving grating plate 6 based on the A phase signal, the B phase signal, and the Z phase signal, a display unit 13 that displays a calculation result, and a lamp driving unit 14 that performs feedback control over the driving of the light source 2.

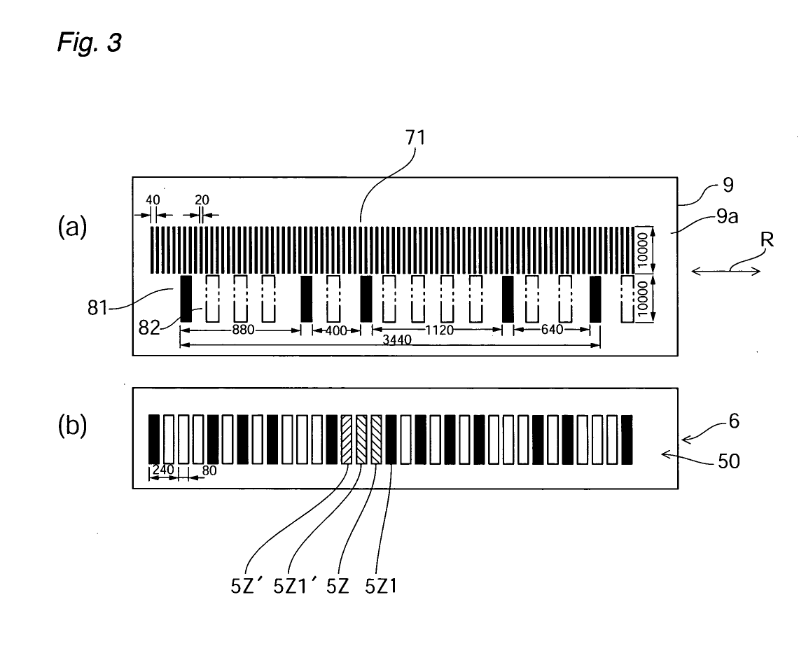

FIG. 3(a) is a schematic diagram showing an alignment pattern of reflective grating sections formed on a surface of the reflective grating plate 9. A surface 9a of the reflective grating plate 9 is disposed so as to be perpendicular to an optical axis L of light emitted from the light source 2 and also to be parallel with a movement direction R of the moving grating plate 6. On this surface 9a, reflective grating sections 71 (A, B phase reflective parts) with fixed widths are aligned with a fixed pitch in a surface part at one end (the upper part in FIG. 3) in a direction perpendicular to the movement direction R. In a surface part of the surface 9a at the other end (the lower part in FIG. 3), reflective grating sections 81 and non-reflective grating sections 82 with a fixed width are aligned in accordance with an alignment pattern produced using random numbers. In the present embodiment, the reflective grating plate 9 is formed from a transparent substrate made of glass or the like, so that only reflective films made of chromium or the like are provided on a surface for defining the reflective grating sections 81. The non-reflective grating sections 82 drawn using imaginary lines in FIG. 3 are illustrated out of convenience for explanatory purposes only.

In the present embodiment, a width of the reflective grating sections 71 for generating the A phase signal and the B phase signal is 20 microns, with the sections 71 being aligned at a pitch of 40 microns. On the other hand, a width of the reflective grating sections 81 and the non-reflective grating sections 82 for generating the Z phase signal is 80 microns, with the sections 81 and 82 being aligned at a pitch of 240 microns.

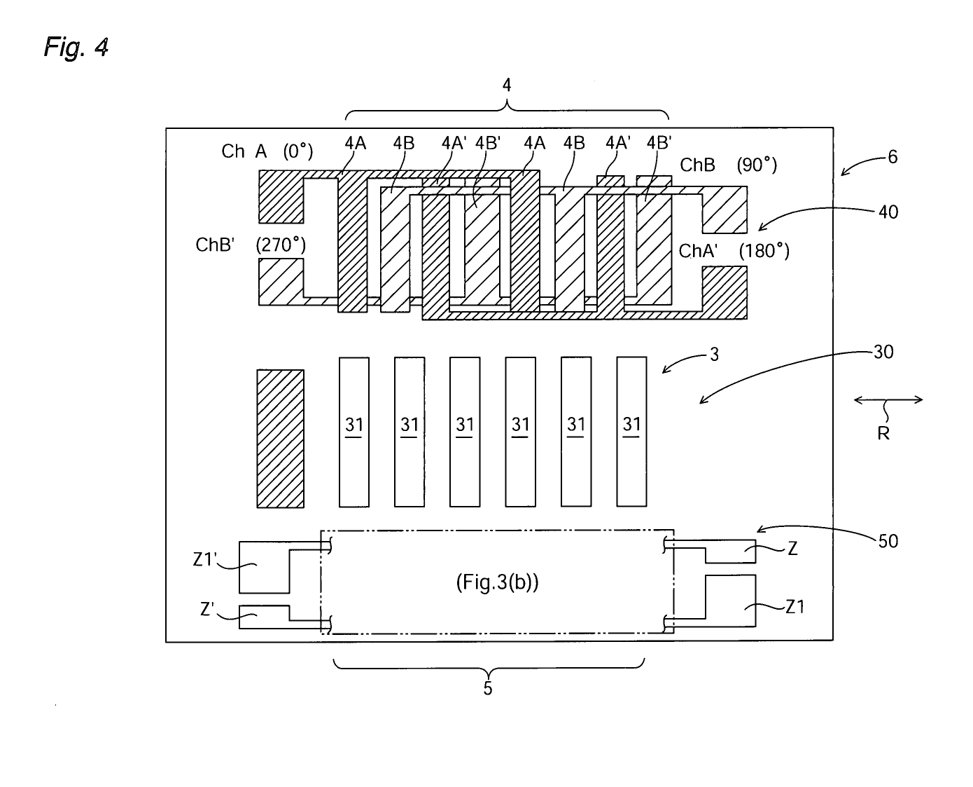

FIG. 4 is a schematic diagram showing the transmissive grating 3 and the sets of photodiodes 4, 5 formed in the moving grating plate 6 that faces the reflective grating plate 9. As shown in FIG. 4, a light transmitting region 30 is formed in a central part of the moving grating plate 6 in a direction that is perpendicular to the movement direction R of the moving grating plate 6. This light transmitting region 30 is composed of the transmissive grating 3 in which transmissive grating sections 31 of a fixed width are disposed in the movement direction R with a fixed pitch. A light receiving region 40 composed of sets of photodiodes 4 for detecting the A phase signal and the B phase signal is formed on one side (the upper side in FIG. 4) of this light transmitting region 30. The sets of photodiodes 4 in the present embodiment include photodiodes 4A for detecting the A phase signal, photodiodes 4B for detecting the B phase signal, photodiodes 4A′ for detecting an A′ phase signal that is an inverse of the A phase signal, and photodiodes 4B′ for detecting a B′ phase signal that is an inverse of the B phase signal. These photodiodes have the same width and are aligned with the same pitch in the movement direction R.

An origin position detection light receiving element region 50 composed of the set of photodiodes 5 for detecting the Z phase signal is formed on the other side (the lower side in FIG. 4) of the light transmitting region 30. As shown in FIG. 3(b), the set of photodiodes 5 in the present embodiment includes photodiodes 5Z, photodiodes 5Z1 for detecting an inverse signal of a detection signal of the photodiodes 5Z, photodiodes 5Z′ for detecting a signal that differs in phase, for example by 90°, relative to the detection signal of the photodiodes 5Z, and photodiodes 5Z1′ for detecting an inverse signal of a detection signal of the photodiodes 5Z′. These photodiodes 5Z, 5Z1, 5Z′, and 5Z1′ are aligned in accordance with an M-series arrangement pattern.

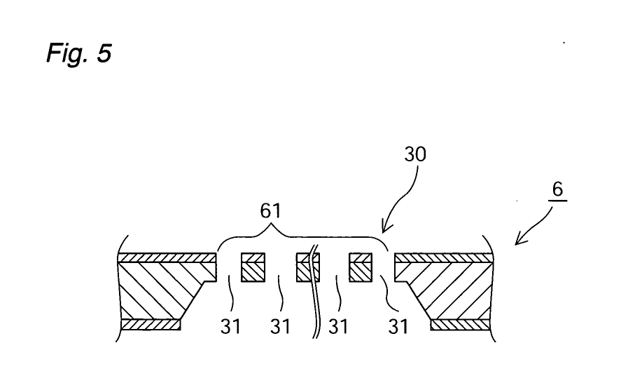

FIG. 5 is an enlarged partial cross-sectional view of the light transmitting region 30 formed in the central part of the moving grating plate 6. As can be understood from FIG. 5, the light transmitting region 30 of the present embodiment is constructed by forming slits with a fixed width and a fixed pitch as the transmissive grating sections 31 by dry etching, such as ICP (Inductively Coupled Plasma etching), on a thin layer part 61 that has been formed by wet etching from the rear surface of the moving grating plate 6.

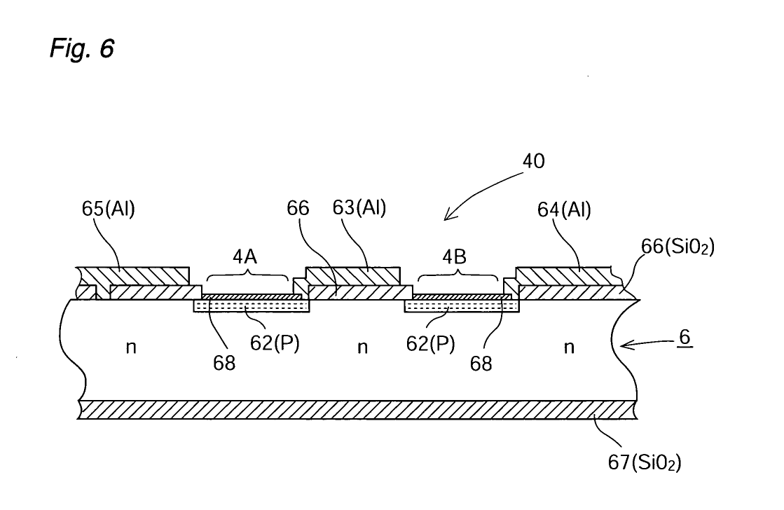

FIG. 6 is an enlarged partial cross-sectional view showing photodiodes 4A, 4B that are included in the sets of photodiodes 4 embedded in a light receiving region 40 of the moving grating plate 6. The set of photodiodes 5 are also the same. As can be understood from FIG. 6, the photodiodes 4A, 4B with pn junctions including a boron-doped layer 62 formed by doping with boron from a front surface of the moving grating plate 6 are embedded in the moving grating plate 6 that is made of a silicon substrate. Respective boron-doped layers 62 of the photodiodes 4A, 4B are connected to electrode wiring layers 63, 64 made of aluminum, and a common electrode layer 65 made of aluminum is connected to one side of an n layer of the moving grating plate 6. The electrode wiring layers 63, 64 and the moving grating plate 6 are insulated from one another by an insulating layer 66 made of a silicon oxide film formed between them. To provide durability, an exposed surface of the moving grating plate 6 is covered with a silicon oxide layer 67. In the same way, surfaces of the boron-doped layers 62 are also covered with a silicon oxide layer 68.

An origin position detecting mechanism for detecting an origin position signal (Z phase signal) in the projection-type linear encoder 1 of the present example includes the set of photodiodes 5 (photodiodes 5Z, 5Z1, 5Z′, 5Z1′) formed in the origin position detection light receiving element region 50 of the moving grating plate 6 described above, the reflective grating sections 81 and the non-reflective grating sections 82 formed in an origin position detection reflective grating region 80 of the reflective grating plate 9, and the signal processing unit 11.

In the present example, an alignment pattern formed using random numbers is used for detecting the origin position. As one example, in the state shown in FIGS. 3(a) and (b), the reflective grating sections 81 are aligned facing the photodiode 5Z so that the maximum amount of light is received. Here, an M-series arrangement pattern may be used. In fact, it is possible to use any arrangement pattern that results in a single peak appearing in the amount of light received by the origin position detection light receiving elements due to a movement of the moving grating plate 6.

In the projection-type linear encoder 1 of the present embodiment constructed as described above, the moving grating plate 6 is integrated with an object to be measured (not shown) and is moved in an alignment direction of the slits and the photodiodes, that is, a direction perpendicular to the optical axis L. Light emitted from the light source 2 first becomes incident on a rear surface of the moving grating plate 6 and is transmitted by the transmissive grating 3 formed in the moving grating plate 6 to become incident in a form of grating stripes on the reflective grating plate 9 that is disposed at a fixed position. Since the reflective gratings 7 and 8 are also formed with the same pitch and the same width on the reflective grating plate 9, out of light incident on the reflective grating plate 9, only the light incident on the reflective gratings 7 and 8 is reflected. An image of the reflective gratings becomes incident on the moving grating plate 6 and the light is received by the sets of photodiodes 4 and 5.

The transmissive grating 3 and photodiodes 4 that are formed on the moving grating plate 6 as vertical stripes function as two grating plates. The reflective grating 7 is also used, and based on triple grating concept, the amount of light received at the sets of photodiodes 4 varies in a sine wave pattern corresponding to a relative movement of the reflective grating 7 on a fixed side and the transmissive grating 3 on a moving side. Accordingly, it is possible to obtain a pulse signal corresponding to a relative movement speed based on photoelectric current of the sets of photodiodes 4, and it is possible to calculate the relative movement speed based on a pulse rate of this pulse signal.

Based on a differential output of the photodiodes 4A and 4A′, it is possible to precisely obtain the A phase signal and based on a differential output of the photodiodes 4B and 4B′, it is possible to precisely obtain the B phase signal. Based on signals of these two phases, it is also possible to determine a direction of movement of the moving grating plate 6.

In the projection-type linear encoder 1 of the present embodiment, an origin signal for detecting an origin position of the moving grating plate 6 can be obtained in addition to the A phase signal and the B phase signal. When the moving grating plate 6 moves, detection signals are obtained from the photodiodes 5Z and 5Z′. When the moving grating plate 6 reaches the origin position (see FIG. 3), a differential signal of the photodiodes 5Z and 5Z′ reaches a maximum level. In the same way a differential signal of the photodiodes 5Z1 and 5Z1′ also reaches a maximum level. As was described with reference to FIG. 10, in the signal processing unit 11, it is possible to obtain an origin signal by comparing these differential signals with a predetermined threshold TH in comparators and taking a logical AND for the respective outputs of the comparators.

### OTHER EXAMPLES

Although an example where the reflective grating plate on which the reflective grating is formed is fixed is described, it is possible for the reflective grating plate to move with the moving plate being fixed.

The light source can be implemented by various kinds of light source such as an LED, a laser source, or a halogen lamp.

Although the above example relates to a linear encoder, the present invention can be applied in the same way to a rotary encoder. In this case, the light transmissive gratings and the photodiodes may be formed at intervals of a fixed angle in a circumferential direction.

In addition, it should be obvious that the present invention can also be applied to a normal reflective-type or projection-type optical encoder.

As described above, according to the present invention, a plurality of transmissive grating sections or reflective grating sections for detecting an origin position and light receiving elements are aligned in accordance with an M-series arrangement pattern or the like, and the width of the transmissive grating sections or reflective grating sections is set wider than transmissive grating sections or reflective grating sections for detecting the A phase signal and the B phase signal. Accordingly, even when the grating pitch is narrow, it can be ensured that a sufficient amount of light is received by the light receiving elements for detecting the origin position signal. A signal shifted by 90° is also generated by the light receiving elements for detecting the origin position signal, and based on the signals, a Z phase signal with a predetermined width is generated.

According to the present invention, it is possible to obtain a Z phase signal with a high output level and a high contrast even when a gap between gratings is wide, such as in a reflective-type or a projection-type optical encoder.

1. A projection-type optical encoder comprising:
a light emitting element,
a moving grating plate with moving transmissive grating sections of a predetermined width that are aligned at a fixed pitch,
a fixed grating plate with fixed transmissive grating sections of a predetermined width that are aligned at a fixed pitch,
a set of light receiving elements that receive light that has been emitted from the light source and has passed through the moving transmissive grating sections and the fixed transmissive grating sections, and
an origin position detecting mechanism for detecting an origin position of the moving grating plate,
wherein the origin position detecting mechanism includes a moving grating region for origin position detection that is formed on the moving grating plate, a fixed grating region for origin position detection that is formed on the fixed grating plate, and a set of light receiving elements for origin position detection that are included in the set of light receiving elements,
transmissive grating sections for origin detection and non-transmissive grating sections for origin detection that are wider than the moving transmissive grating sections and the fixed transmissive grating sections are aligned in the moving grating region and the fixed grating region, respectively,
the set of light receiving elements for origin position detection includes a set of Z phase light receiving elements that generate a Z phase signal and a set of Z′ phase light receiving elements that generate a Z′ phase signal that differs in phase to the Z phase signal,
an alignment pattern of grating sections in the moving grating region and the fixed grating region and an alignment pattern of the set of Z phase light receiving elements and the set of Z′ phase light receiving elements are determined so that one peak respectively appears in amounts of light received by the set of Z phase light receiving elements and the set of Z′ phase light receiving elements when the moving grating plate moves, and
the origin position of the moving grating plate is detected based on the Z phase signal and the Z′ phase signal.

2. A projection-type optical encoder comprising:
a light emitting element,
a moving grating plate with moving transmissive grating sections of a predetermined width that are aligned at a fixed pitch,
a fixed grating plate with fixed transmissive grating sections of a predetermined width that are aligned at a fixed pitch,
a set of light receiving elements that receive light that has been emitted from the light source and has passed through the moving transmissive grating sections and the fixed transmissive grating sections, and
an origin position detecting mechanism for detecting an origin position of the moving grating plate,
wherein the origin position detecting mechanism includes a moving grating region for origin position detection that is formed on the moving grating plate, a fixed grating region for origin position detection that is formed on the fixed grating plate, and a set of light receiving elements for origin position detection that are included in the set of light receiving elements,
transmissive grating sections for origin detection and non-transmissive grating sections for origin detection that are wider than the moving transmissive grating sections and the fixed transmissive grating sections are aligned in the moving grating region and the fixed grating region, respectively, in accordance with an M-series arrangement pattern,
the set of light receiving elements for origin position detection includes a set of Z phase light receiving elements that generate a Z phase signal and a set of Z′ phase light receiving elements that generate a Z′ phase signal that differs in phase to the Z phase signal, the set of Z phase light receiving elements being aligned in accordance with the M-series arrangement pattern, and
the origin position of the moving grating plate is detected based on the Z phase signal and the Z′ phase signal.

3. An optical encoder according to claim 1,
wherein the set of light receiving elements includes a set of inverse Z phase light receiving elements that generate an inverse Z phase signal that is an inverse signal of the Z phase signal and a set of inverse Z′ phase light receiving elements that generate an inverse Z′ phase signal that is an inverse signal of the Z′ phase signal, and
the origin position of the moving grating plate is detected based on a differential signal of the Z phase signal and the inverse Z phase signal and a differential signal of the Z′ phase signal and the inverse Z′ phase signal.

4. A reflective-type optical encoder comprising:
a light emitting element,
a moving grating plate with moving reflective grating sections of a predetermined width that are aligned at a fixed pitch,
a fixed grating plate with fixed transmissive grating sections of a predetermined width that are aligned at a fixed pitch,
a set of light receiving elements that receive light that has been emitted from the light source, reflected by the moving reflective grating sections, and has passed through the fixed transmissive grating sections, and
an origin position detecting mechanism for detecting an origin position of the moving grating plate,
wherein the origin position detecting mechanism includes a moving grating region for origin position detection that is formed on the moving grating plate, a fixed grating region for origin position detection that is formed on the fixed grating plate, and a set of light receiving elements for origin position detection that are included in the set of light receiving elements,
reflective grating sections for origin detection and non-reflective grating sections for origin detection that are wider than the moving reflective grating sections and the fixed transmissive grating sections are aligned in the moving grating region and the fixed grating region respectively,
transmissive grating sections for origin detection and non-transmissive grating sections for origin detection that are wider than the moving reflective grating sections and the fixed transmissive grating sections are aligned in the fixed grating region,
the set of light receiving elements for origin position detection includes a set of Z phase light receiving elements that generate a Z phase signal and a set of Z′ phase light receiving elements that generate a Z′ phase signal that differs in phase to the Z phase signal,
an alignment pattern of grating sections in the moving grating region and the fixed grating region and an alignment pattern of the set of Z phase light receiving elements and the set of Z′ phase light receiving elements are determined so that one peak respectively appears in each amount of light received by the set of Z phase light receiving elements and the set of Z′ phase light receiving elements when the moving grating plate moves, and
the origin position of the moving grating plate is detected based on the Z phase signal and the Z′ phase signal.

5. A reflective-type optical encoder comprising:
a light emitting element,
a moving grating plate with moving reflective grating sections of a predetermined width that are aligned at a fixed pitch,
a fixed grating plate with fixed transmissive grating sections of a predetermined width that are aligned at a fixed pitch,
a set of light receiving elements that receive light that has been emitted from the light source, has been reflected by the moving reflective grating sections, and has passed through the fixed transmissive grating sections, and
an origin position detecting mechanism for detecting an origin position of the moving grating plate,
wherein the origin position detecting mechanism includes a moving grating region for origin position detection that is formed on the moving grating plate, a fixed grating region for origin position detection that is formed on the fixed grating plate, and a set of light receiving elements for origin position detection that are included in the set of light receiving elements,
reflective grating sections for origin detection and non-reflective grating sections for origin detection that are wider than the moving reflective grating sections and the fixed transmissive grating sections are aligned in the moving grating region and the fixed grating region, respectively, in accordance with an M-series arrangement pattern,
transmissive grating sections for origin detection and non-transmissive grating sections for origin detection that are wider than the moving reflective grating sections and the fixed transmissive grating sections are aligned in the fixed grating region in accordance with the M-series arrangement pattern,
the set of light receiving elements for origin position detection includes a set of Z phase light receiving elements that generate a Z phase signal and a set of Z′ phase light receiving elements that generate a Z′ phase signal that differs in phase to the Z phase signal, the set of Z phase light receiving elements being aligned in accordance with the M-series arrangement pattern, and
the origin position of the moving grating plate is detected based on the Z phase signal and the Z′ phase signal.

6. An optical encoder according to claim 4,
wherein the set of light receiving elements includes a set of inverse Z phase light receiving elements that generate an inverse Z phase signal that is an inverse signal of the Z phase signal and a set of inverse Z′ phase light receiving elements that generate an inverse Z′ phase signal that is an inverse signal of the Z′ phase signal, and
the origin position of the moving grating plate is detected based on a differential signal of the Z phase signal and the inverse Z phase signal and a differential signal of the Z′ phase signal and the inverse Z′ phase signal.
